(19) United States
(12) Patent Application Publication
(10) Pub. No.: US 2026/0178671 A1
(43) Pub. Date: Jun. 25, 2026

(54) SYSTEM AND METHOD FOR GENERATING PERSONALIZED USER FEED

(71) Applicants: Kshitij Prasad TIWARI, Hyderabad (IN); Alamelu KRISHNAMOORTHY, Hyderabad (IN)

(72) Inventors: Kshitij Prasad TIWARI, Hyderabad (IN); Alamelu KRISHNAMOORTHY, Hyderabad (IN)

(21) Appl. No.: 18/836,750

(22) PCT Filed: Jul. 8, 2024
(86) PCT No.: PCT/IB2024/056649

§ 371 Date: Aug. 7, 2024

(30) Foreign Application Priority Data
Jul. 22, 2023 (IN) 202341036586

(51) Int. Cl. G06F 16/9535; G06F 16/9536; G06F 40/279; G06N 20/00; G06Q 10/42; G06Q 10/44; G06Q 30/0251

(52) U.S. Cl. CPC G06F 16/9535; G06F 16/9536; G06F 40/279; G06N 20/00; G06Q 10/42; G06Q 10/44; G06Q 30/0258; G06Q 30/0269

(57) ABSTRACT

The present invention discloses a method and a system that provides personalized user feed to a user. The method comprises creating a personalized user feed by first establishing a user profile derived from inputs reflecting user intent, preferences, and interests. Further, the method extracts keywords, topics, and themes from the user profile to discern user preferences by utilizing natural language processing (NLP) techniques. Further, the method generates a personalized feed by aggregating content from various sources, considering a weighted topic distribution, user preferences, and intent. The aggregated content is ranked and prioritized based on user preferences, content recency, and user sentiment. The personalized user feed is then provided to the user on the platform, ensuring a tailored and relevant content experience. The disclosed method and system leverage advanced NLP techniques and dynamic content ranking to enhance user engagement and satisfaction by delivering highly personalized content.

### CROSS-REFERENCE TO RELATED APPLICATIONS AND PRIORITY

The present application claims priority from the patent application having application number: 202341036586 and filed on 22 Jul. 2023 incorporated herein by your reference.

### TECHNICAL FIELD

The present subject matter described herein, in general, relates to providing content in a digital networking platform. More particularly, the present subject matter relates to a system and a method that delivers personalized user feed on the networking platform for users by leveraging advanced algorithms, artificial intelligence, and mechanisms that analyze user interactions, preferences, and intent.

### BACKGROUND

In today's digital landscape, the ability to provide customized and relevant content to users is paramount. Businesses across various industries are increasingly recognizing the need for systems that can generate user-oriented feeds, which can significantly enhance user engagement, satisfaction, and retention. This is particularly important in the B2B (business-to-business) sector, where the stakes are high and the content in the user-oriented feeds needs to be highly specialized and tailored to the unique needs of business clients.

Moreover, in a B2B environment, curated feeds can drive better decision-making, foster deeper client relationships, and streamline workflows by ensuring that users receive timely and pertinent information. For example, a procurement officer might need updates on supply chain distributions, while a marketing executive might focus on the latest industry trends and competitor activities.

With the proliferation of smart phones, access to the content is shifting away from search engines to consuming content directly within mobile applications. As a result, a number of mobile content applications have been developed, including well known commercial systems.

However, conventional mobile content applications rely on social media feeds, personalized search results, and recommendations to develop algorithmically curated content in a user's daily digital life. Traditional algorithms and the AI personalization tools that curate the content for the user have a significant influence on the way users interact with social media, however they are largely hidden behind the user interface, making them invisible to the users.

Additionally, various digital platforms and modules are developed to curate data in a much more personalized manner for better experience. Such platforms offer algorithms that filter information into selections that are presumably to be useful to consumers. However, these current online advertising and e-commerce platforms only communicate with users on a superficial level depending on the way the users engage with other websites, and not necessarily based on the authorization or consent of the user.

Existing approaches to curating content exhibit significant limitations. The individualized nature of information encounters is often overlooked in much of the media research related to business environments. For instance, content analysis frequently collects articles directly from various websites, implicitly assuming that all business users encounter the same content. This approach fails to recognize the unique needs and preferences of individual business users, thus preventing them from curating their experience on the platform based on their specific professional requirements.

Conventional systems often fall short in addressing the complex requirements of users, typically relying on generic algorithms that fail to account for the specific preferences, professional interests, and organizational roles of individual users. As a result, business users are frequently inundated with irrelevant content, leading to inefficiencies and missed opportunities for meaningful engagement. The users require content that is not only relevant but also tailored to their unique roles and objectives within their organizations. For example, a financial analyst may need in-depth market analyses and economic forecasts, while a supply chain manager might prioritize updates on logistics and inventory management.

Current systems do not adequately address these needs, often delivering generic or irrelevant information that does not align with the user's specific context or priorities, thereby diminishing the effectiveness and efficiency of these platforms in serving their clientele.

Further, conventional digital platforms typically offer a user experience that is heavily dictated by algorithms focusing on immediate network interactions and past behaviors, rather than allowing users to curate their experiences based on their evolving preferences and interests. This leads to a situation where user interactions and content exposure are predominantly influenced by the activities within their immediate social network or their historical behavior patterns. For example, users might frequently see posts and advertisements from friends, family, or groups they belong to, as well as targeted advertisements based on previous clicks or browsing history. This approach can significantly limit the diversity of content and interactions that a user encounters, as it primarily reinforces existing behaviors and connections rather than introducing new, potentially enriching content. Also, each interaction such as a click or browsing history may not directly indicate the user's preferences and intent.

The core issue with the conventional model is that it largely overlooks the dynamic nature of user interests and the potential for discovering new content outside of their established behavior patterns. Users'interests can change over time, and they may seek out information or experiences that are not reflected in their past interactions. However, the current algorithmic models used by many platforms do not account for these shifts effectively. Instead, they continue to prioritize content that aligns with past behaviors or is popular within the user's immediate network. This can lead to a monotonous user experience and hinder the user's ability to explore new topics, ideas, and connections that they might find valuable or engaging. Consequently, there is a growing need for digital platforms to implement more sophisticated content curation mechanisms that prioritize user-defined preferences and intent, allowing for a more personalized and enriching user experience.

Additionally, conventional systems often curate content without explicit user consent, relying heavily on implicit data gathered from user behavior, such as clicks, likes, and browsing history. These systems infer user preferences and interests based on past interactions rather than directly soliciting input from users about their current interests or desired content. This lack of explicit consent can result in a misalignment between the content presented and the user's actual preferences at any given moment. Users may feel that their autonomy is compromised as the platform dictates their content experience based on inferred data, leading to potential frustration and disengagement. The absence of mechanisms to allow users to directly influence or curate their content experience underscores a significant limitation in these systems, highlighting the need for more transparent and user-driven content curation methodologies.

In view of the above, there is a long-felt need for providing an improved system for users that is configured to deliver customized feeds that enable wide-scale management of web service providers and web service consumers in a much more transparent and efficient manner.

### SUMMARY

This summary is provided to introduce concepts related to a system and method for generating user-oriented feed. This summary is not intended to identify essential features of the claimed subject matter, nor it is intended for use in determining or limiting the scope of the disclosed subject matter.

In accordance with an embodiment of the present subject matter, a system and method for generating user-oriented feed is described herein. In one embodiment, a method to create a personalized user feed is disclosed. The method may comprise a step of creating a user profile based on a user input indicative of user intent, user preferences, and user interests. Further, the method may comprise a step of analyzing the user profile to extract one or more preferences of the user by utilizing at least one of a keyword, a topic, and a theme, extracted from the user profile using one or more natural language processing (NLP) techniques. The method further may comprise a step of generating the personalized user feed from content posted within a platform. In an embodiment, the method for generating the personalized user feed comprises various steps. The method may comprise a step of aggregating content from a plurality of sources based on a weighted topic distribution, user preferences, and user intent. Further, the method may comprise a step of ranking and prioritizing the aggregated content based on the extracted one or more preferences, recency of the aggregated content, and an user sentiment. The method further may comprise a step of providing the personalized user feed on the platform to the user.

In another embodiment, the system is configured to create a personalized user feed. The system may include an electronic device configured for displaying the personalized user feed on a platform. Further, the system may include a processor and a memory coupled to the processor for storing instructions and for further execution. The processor is configured to create a user profile based on an user input indicative of user intent, user preferences, and user interests. Further, the processor is configured to analyze the user profile to extract one or more preferences of the user by utilizing at least one of a keyword, a theme, and a topic, extracted from the user profile using one or more natural language processing (NLP) techniques. The processor is further configured to generate the personalized user feed from content posted within the platform. In an embodiment, the processor is configured to generate the personalized user feed by aggregating content from a plurality of sources based on a weighted topic distribution, user preferences, and user intent, followed by ranking and prioritizing the aggregated content based on the extracted one or more preferences, recency of the aggregated content, and the user sentiment. Further, the processor is configured to provide the personalized user feed on the platform to the user.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which

FIG. 1 is a block diagram that illustrates a system environment (100) in which various embodiments of a method and a system for creating a personalized user feed may be implemented.

FIG. 2 is a block diagram (200) that illustrates an application server configured for creating the personalized user feed, in accordance with an embodiment of the present invention.

FIG. 3 is a flowchart (300) that illustrates a method for creating the personalized user feed, in accordance with an embodiment of the present invention.

FIG. 4 illustrates a block diagram (400) of an exemplary computer system for implementing embodiments consistent with the present disclosure.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. It must also be noted that, the singular forms “a,” “an,” and “the” include plural references unless the context clearly dictates otherwise. Although any methods similar or equivalent to those described herein can be used in the practice or testing of embodiments of the present disclosure, the exemplary methods are described. The disclosed embodiments are merely exemplary of the disclosure, which may be embodied in various forms.

A non-limiting objective of the present invention is to overcome the disadvantages of the prior art. An objective of the present disclosure is to provide an improved method and system for delivering highly relevant and personalized content to users based on explicit preferences, intent, and consent from the users. Another objective of the present disclosure is to enhance user satisfaction by ensuring that the content delivered aligns closely with the user intent and the preferences, rather than relying solely on inferred behaviors. Yet another objective of the present disclosure is to create a digital platform that facilitates seamless collaboration and networking among manufacturers, suppliers, innovators, and industry experts.

Yet another objective of the present disclosure is to implement advanced machine learning techniques to accurately match content with user profiles, resulting in an enhancement in the field of content management and generation of the personalized user feed. Yet another objective of the present disclosure is to provide an user-friendly interface that allows the users to easily input and manage the preferences, intent, and interests, thereby ensuring a personalized and intuitive experience. Yet another objective of the present disclosure is to foster an inclusive and transformative experience for all stakeholders in the manufacturing industry, promoting growth, innovation, and the development of market-dominating products.

The foregoing and other objects of the present invention will become readily apparent upon further review of the following detailed description of the embodiments as illustrated in the accompanying drawings.

The present invention relates to a method (300) and system (100) for generating a personalized feed for the user. The personalized feed is achieved by introducing a selection of concepts, keywords, topics and themes in a simplified form for identifying user's preference and accordingly delivering the content.

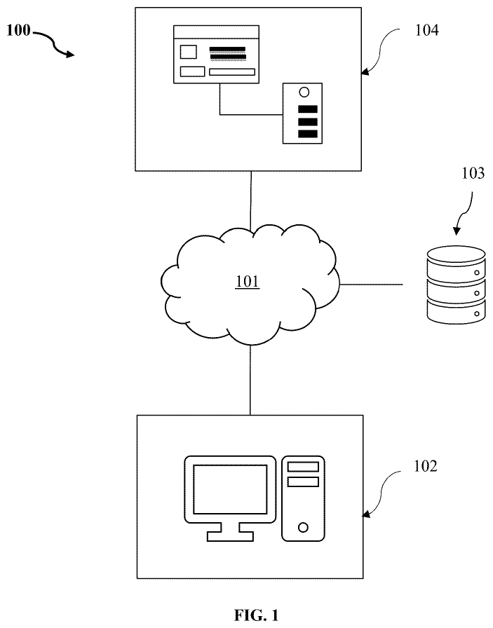

Referring to FIG. 1, a block diagram illustrates a system environment (100) in which various embodiments of the method (300) and the system (100) may be implemented. The system environment (100) typically includes a database server (103), an application server (104), a communication network (101), and an electronic device (102).

The database server (103), the application server (104), and the electronic device (102) are typically communicatively coupled with each other via the communication network (101). In an embodiment, the application server (104) may communicate with the database server (103), and the electronic device (102) using one or more protocols such as, but not limited to, Hypertext Transfer Protocol (HTTP), Transmission Control Protocol/Internet Protocol (TCP/IP), Wireless Application Protocol (WAP), RF mesh, Bluetooth Low Energy (BLE), and the like, to communicate with one another.

In an embodiment, the database server (103) may refer to a computing device that may be configured to store the user profile of a plurality of users. Further, the database server (103) may be configured to store the personalized user feed. In an embodiment, the database server (103) may include a special purpose operating system (100) specifically configured to perform one or more database operations on the stored content. Examples of database operations may include, but are not limited to, Select, Insert, Update, and Delete. In an embodiment, the database server (103) may include hardware that may be configured to perform one or more predetermined operations.

In an embodiment, the database server (103) may be realized through various technologies such as, but not limited to, Microsoft® SQL Server, Oracle@, IBM DB2®, Microsoft Access®, PostgreSQL®, MySQL®, SQLite®, distributed database technology, and the like. In an embodiment, the database server (103) may be configured to utilize the application server (104) for storage and retrieval of data used for securely performing one or more operations in the platform where the personalized user feed is provided to the user.

A person with ordinary skills in art will understand that the scope of the disclosure is not limited to the database server (103) as a separate entity. In an embodiment, the functionalities of the database server (103) can be integrated into the application server (104) or into the electronic device (102).

In an embodiment, the application server (104) may refer to a computing device or a software framework hosting an application or a software service. In an embodiment, the application server (104) may be implemented to execute procedures such as, but not limited to, programs, routines, or scripts stored in one or more memories for supporting the hosted application or the software service. In an embodiment, the hosted application or the software service may be configured to perform one or more predetermined operations. The application server (104) may be realized through various types of application servers such as, but are not limited to, a Java application server, a .NET framework application server, a Base4 application server, a PHP framework application server, or any other application server framework.

In an embodiment, the application server (104) may be configured to utilize the database server (103) and the electronic device (102), in conjunction, for securely performing one or more operations in the platform. In an embodiment, the application server (104) corresponds to the user interface platform for generating the personalized user feed from content posted within the platform. In an embodiment, the application server (104) may be configured to create a user profile based on a user input indicative of user intent, user preferences, and user interests. In an embodiment, the application server (104) may be configured to analyze the user profile to extract one or more preferences of the user by utilizing at least one of a keyword, a topic, and a theme, extracted from the user profile using one or more natural language processing (NLP) techniques.

In an embodiment, the application server (104) may be configured to generate the personalized user feed from content posted within the platform by aggregating content from a plurality of sources based on a weighted topic distribution, user preferences, and user intent. Further, the the application server (104) may be configured to generate the personalized user feed from content posted within the platform by ranking and prioritizing the aggregated content based on the extracted one or more preferences, recency of the aggregated content, and a user sentiment. In an embodiment, the application server (104) may be configured to provide the personalized user feed on the platform to the user

In an embodiment, the communication network (101) may correspond to a communication medium through which the application server (104), the database server (103), and the electronic device (102) may communicate with each other. Such a communication may be performed in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), Wireless Application Protocol (WAP), File Transfer Protocol (FTP), ZigBee, EDGE, infrared IR), IEEE 802.11, 802.16, 2G, 3G, 4G, 5G, 6G, 7G cellular communication protocols, and/or Bluetooth (BT) communication protocols. The communication network (101) may either be a dedicated network or a shared network.

Further, the communication network (101) may include a variety of network devices, including routers, bridges, servers, computing devices, storage devices, and the like. The communication network (106) may include, but is not limited to, the Internet, intranet, a cloud network, a Wireless Fidelity (Wi-Fi) network, a Wireless Local Area Network (WLAN), a Local Area Network (LAN), a cable network, the wireless network, a telephone network (e.g., Analog, Digital, POTS, PSTN, ISDN, xDSL), a telephone line (POTS), a Metropolitan Area Network (MAN), an electronic positioning network, an X.25 network, an optical network (e.g., PON), a satellite network (e.g., VSAT), a packet-switched network, a circuit-switched network, a public network, a private network, and/or other wired or wireless communications network configured to carry data.

In an embodiment, the one or more electronic devices (102) may refer to a computing device used by a user. The one or more electronic devices (102) may comprise one or more processors (201) and one or more memory (202). The one or more memories may include computer readable code that may be executable by one or more processors (201) to perform predetermined operations. In an embodiment, the one or more electronic devices (102) may present an user interface to interact with the platform and provide the personalized user feed on the platform to the user. Example user interfaces presented on the one or more electronic devices (102) may be configured to display a portal visualizing user profile and relevant information, to securely perform one or more operations in the user interface platform. Examples of the one or more electronic devices (102) may include, but are not limited to, a personal computer, a laptop, a personal digital assistant (PDA), a mobile device, a tablet, or any other computing device.

The system (100) can be implemented using hardware, software, or a combination of both, which includes using where suitable, one or more computer programs, mobile applications, or “apps” by deploying either on-premises over the corresponding computing terminals or virtually over cloud infrastructure. The system (100) may include various micro-services or groups of independent computer programs which can act independently in collaboration with other micro-services. The system (100) may also interact with a third-party or external computer system.

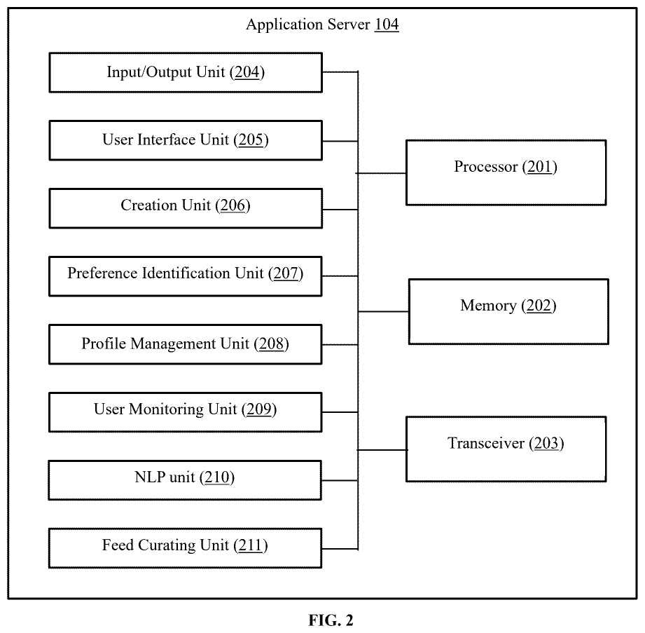

Referring to FIG. 2, a block diagram (200) for the application server (104) is illustrated and the application server (104) is configured for stepwise providing the personalized user feed on the platform to the user. The application server (104) includes the following key components: a processor (201), a memory (202), a transceiver (203), an input/output unit (204), an user interface unit (205), a creation unit (206), a preference identification unit (207), a profile management unit (208), an user monitoring unit (209), a NLP unit (210), and a feed curating unit (211).

The application server (104) includes the following key components as user interface unit (205) which allows users to input their preferences, intent, and interests. The application server (104) includes interfaces for various content formats such as text, image, video, and audio. Further, the profile management unit (208) is responsible for creating and maintaining user profiles based on the input provided by the users. The user profiles include detailed information on the user intent, the interests, the historical interactions, and the engagement metrics.

The processor (201) comprises suitable logic, circuitry, interfaces, and/or code that may be configured to execute a set of instructions stored in the memory (202), and may be implemented based on several processor technologies known in the art. The processor (201) works in coordination with the transceiver (203), the input/output unit (204), the user interface unit (205), the creation unit (206), the preference identification unit (207), the profile management unit (208), the user monitoring unit (209), the NLP unit (210), and the feed curating unit (211), for providing (306) the personalized user feed on the platform to the user.

Examples of the processor (201) include, but not limited to, a standard microprocessor, microcontroller, central processing unit (CPU), an X86-based processor, a Reduced Instruction Set Computing (RISC) processor, an Application-Specific Integrated Circuit (ASIC) processor, and a Complex Instruction Set Computing (CISC) processor, distributed or cloud processing unit, state machines, logic circuitries, and/or any devices that manipulate signals based on operational instructions and/or other processing logic that accommodates the requirements of the present invention.

The memory (202) comprises suitable logic, circuitry, interfaces, and/or code that may be configured to store the set of instructions, which are executed by the processor (201). Preferably, the memory (202) is configured to store one or more programs, routines, or scripts that are executed in coordination with the processor (201). Additionally, the memory (202) may include any computer-readable medium or computer program product known in the art including, for example, volatile memory, such as static random-access memory (SRAM) and dynamic random-access memory (DRAM), and/or non-volatile memory, such as read-only memory (ROM), erasable programmable ROM, a Hard Disk Drive (HDD), flash memories, Secure Digital (SD) card, Solid State Disks (SSD), optical disks, magnetic tapes, memory cards, virtual memory and distributed cloud storage.

The memory (202) may be removable, non-removable, or a combination thereof. Further, the memory (202) may include routines, programs, objects, components, data structures, etc., which perform particular tasks or implement particular abstract data types. The memory (202) may include programs or coded instructions that supplement the applications and functions of the system (100). In one embodiment, the memory (202), amongst other things, serves as a repository for storing data processed, received, and generated by one or more of the programs or the coded instructions. In yet another embodiment, the memory (202) may be managed under a federated structure that enables the adaptability and responsiveness of the application server (104).

The transceiver (203) comprises suitable logic, circuitry, interfaces, and/or code that may be configured to receive, process or transmit information, data or signals, which are stored by the memory (202) and executed by the processor (201). The transceiver (203) is preferably configured to receive, process or transmit, one or more programs, routines, or scripts that are executed in coordination with the processor (201). The transceiver (203) is preferably communicatively coupled to the communication network (101) of the system (100) for communicating all the information, data, signals, programs, routines or scripts through the network.

The transceiver (203) may implement one or more known technologies to support wired or wireless communication with the communication network (101). In an embodiment, the transceiver (203) may include but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. Also, the transceiver (203) may communicate via wireless communication with networks, such as the Internet, an Intranet and/or a wireless network, such as a cellular telephone network, a wireless local area network (LAN) and/or a metropolitan area network (MAN).

Accordingly, the wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VOIP), Wi-MAX, a protocol for email, instant messaging, and/or Short Message Service (SMS).

The input/output (I/O) unit (204) comprises suitable logic, circuitry, interfaces, and/or code that may be configured to receive or present information. The input/output unit (204) comprises various input and output devices that are configured to communicate with the processor (201). Examples of the input devices include but are not limited to, a keyboard, a mouse, a joystick, a touch screen, a microphone, a camera, and/or a docking station. Examples of the output devices include, but are not limited to, a display screen and/or a speaker. The I/O unit (204) may include a variety of software and hardware interfaces, for example, a web interface, a graphical user interface, and the like. The I/O unit (204) may allow the system (100) to interact with the user directly or through the electronic device.

Further, the I/O unit (204) may enable the system (100) to communicate with other computing devices, such as web servers and external data servers (not shown). The I/O unit (204) can facilitate multiple communications within a wide variety of networks and protocol types, including wired networks, for example, LAN, cable, etc., and wireless networks, such as WLAN, cellular, or satellite. The I/O unit (204) may include one or more ports for connecting a number of devices to one another or to another server. In one embodiment, the I/O unit (204) allows the application server (104) to be logically coupled to other user computing devices, some of which may be built in. Illustrative components include tablets, mobile phones, wireless devices, etc.

Further, the input/output (I/O) (204) unit may comprise a display module, an input module, and a communication module. The display module may present content to the user, the input module may allow the user to provide preferences, interests, and other relevant information, and the communication module may facilitate the exchange of data between the user's electronic device (102) and the platform, ensuring seamless interaction and content delivery. Further, the input/output (I/O) (204) unit may be configured to provide a user interface to provide feedback on the content received. These components work together to facilitate user interaction and improve the tailoring of content delivery based on user input and feedback.

The creation unit (206) may include suitable logic, circuitry, interfaces, and/or code that may be configured to generate user profiles by aggregating and analyzing data inputs. The creation unit (206) utilizes advanced artificial intelligence and machine learning techniques to collect and interpret user behavior, preferences, and demographic information from various sources. The creation unit (206) systematically processes the collected data to construct comprehensive and accurate profiles that may be used for personalized user experiences, targeted marketing, and enhanced user engagement. The creation unit (206) ensures data integrity and privacy through robust encryption and compliance with data protection regulations, providing a secure and efficient solution for profile creation in digital systems.

The preference identification unit (207) may include suitable logic, circuitry, interfaces, and/or code that may be configured to ascertain user preferences with explicit intent and consent, ensuring a user-centric and ethically sound approach to data handling. The preference identification unit (207) unit employs sophisticated artificial intelligence and machine learning techniques to interpret user interactions and feedback to accurately identify individual preferences across various contexts and platforms. The preference identification unit (207) operates with a strong emphasis on explicit user consent, utilizing transparent mechanisms to obtain and verify permissions before any data processing occurs. By prioritizing explicit user intent and consent, the preference identification unit (207) not only enhances the personalization and relevance of user experiences but also aligns with stringent privacy standards and regulatory requirements, thereby fostering trust and compliance in digital environments.

The profile management unit (208) may include suitable logic, circuitry, interfaces, and/or code that may be configured to maintain the user accounts and optimize user interaction with the system (100). The profile management unit (208) is configured to handle various aspects of user account management, including profile updates, authentication, and preference settings. The profile management unit (208) prioritizes user convenience and engagement, fostering a seamless and productive interaction environment. Further, the profile management unit (208) aggregates the content from a plurality of sources based on a weighted topic distribution.

The user monitoring unit (209) is an advanced analytical module that may include suitable logic, circuitry, interfaces, and/or code that may be configured to perform sentiment analysis on user interaction data to determine users'sentiments towards various types of content in their feed. The user monitoring unit (209) may be configured to analyze the text, emojis, and engagement patterns, such as likes, shares, and comments to discern positive, negative, or neutral user sentiments. The real-time analysis enables a deeper understanding of user preferences and emotional responses, allowing for the dynamic adjustment of content/personalized user feed to enhance user satisfaction and engagement. Additionally, the user monitoring unit (209) ensures data privacy and security while maintaining high accuracy in sentiment detection, providing valuable insights for personalized content delivery and strategic decision-making.

The NLP unit (210) may include suitable logic, circuitry, interfaces, and/or code that may be configured to analyze user profiles to extract specific user preferences using advanced natural language processing techniques. By leveraging NLP techniques designed to interpret and understand human language, the NLP unit (210) identifies and extracts keywords, topics, and themes from the user profile data. Such sophisticated analysis enables the system (100) to discern user interests and preferences with high accuracy. The extracted information may include preferences for particular products, content, or activities, thereby allowing the system (100) to tailor recommendations, enhance user interactions, and personalize user experiences effectively. The NLP unit (210) ensures that the extracted preferences are relevant and precise, thereby enhancing the overall functionality and user satisfaction of the digital system (100).

The feed curating unit (211) may include suitable logic, circuitry, interfaces, and/or code that may be configured to generate personalized user feeds from content posted within a platform (interchangeably referred to as a networking platform). By leveraging the data from NLP unit (210) and user monitoring unit (209), the feed curating unit (211) analyzes and curates a tailored feed of relevant content. The feed curating unit (211) ensures that the user experience is optimized, presenting a constantly updated, personalized stream of information that enhances user satisfaction and engagement. The feed curating unit (211) operates with high efficiency, maintaining real-time processing capabilities to adapt to evolving user interests and trends within the platform.

In operation, the system (100) may function by first receiving user input, which may include user intent, preferences, and user interests. The user input is then processed through various modules, such as the creation unit (206) for creating (301) a user account, preference identification unit (207) for determining user preferences, profile management unit (208) for updating and authenticating user's preferences, NLP unit (210) for analyzing the preference, user monitoring unit (209) for sentimental analysis to derive valuable insights, which inform future content strategies. The feed curating unit (211) may handle delivering personalized feed, allowing for targeted promotions and advertisements based on user segments and preferences. Throughout this process, feedback from the users may be incorporated to continually refine and enhance the system's (100) recommendations and content delivery mechanisms for the personalized user feed on the platform to the user.

The user input may include selections of industry type, sub-industry type, areas of interest, categories, technologies, knowledge areas, and countries. For instance, a user may indicate an interest in the technology industry, specifically in the sub-industries of AI and machine learning. The user input may be processed by the system's processor (201) to create detailed user profiles. The user profiles may contain comprehensive information such as user intent, historical interactions, engagement metrics, and professional roles, providing a rich dataset to tailor the user experience. Once the profiles are created, the system (100) may segment them based on the received input.

Further, after creation of the user profile, the user monitoring unit (209) may be configured to analyze and organize the user's preferences into categorical data, such as industry types, sub-industry types, areas of interest, and professional roles. The categorical data may then be converted into numerical vectors using techniques like one-hot encoding, label encoding, or embedding representations. Clustering techniques, such as K-Means Clustering, Hierarchical Clustering, or Density-Based Spatial Clustering, may be applied to group similar profiles together. The analyzed profiles may be grouped into distinct user groups with similar characteristics and intents, and each group may be assigned a label for easy identification. The system (100) may then receive content from the users, which may be in the form of promotions, advertisements, or queries. Thus, the system not only provides a user-oriented feed but also provides meaningful connection between the like-minded users.

For example, a manufacturer may post an advertisement about a new sustainable product, or a consultant may post a query seeking information on the latest industry trends in the field of sustainability. The processor (201) may use machine learning techniques to identify the content related to the sustainable solution developing in the market. This identification may involve training a supervised machine learning model based on the user input and data in each profile.

Features from the content may be extracted using NLP techniques, such as Term Frequency-Inverse Document Frequency (TF-IDF), word embeddings, and BERT embeddings, to capture the semantic meaning of the content. A similarity index may be determined between the features of the content and the user profiles, and the system (100) may predict the probability of relevance for each user profile-content pair. Further, the tailored content may then be provided to the relevant users based on their segmented profiles and user input. The content may be displayed on the user interface in various formats, including text, images, videos, or audio. This ensures that users may receive content in their preferred format, enhancing their engagement and experience. The content being displayed on the user's feed is mainly based on trends, and actionable information derived from analyzing user interactions, preferences, user intent, and engagement metrics. Furthermore, the platform may include feedback mechanisms allowing users to rate the relevance of the provided content in the personalized user feed. By incorporating these detailed steps, the platform may provide a comprehensive solution for personalized content delivery, fostering a more engaging and effective user experience on the platform.

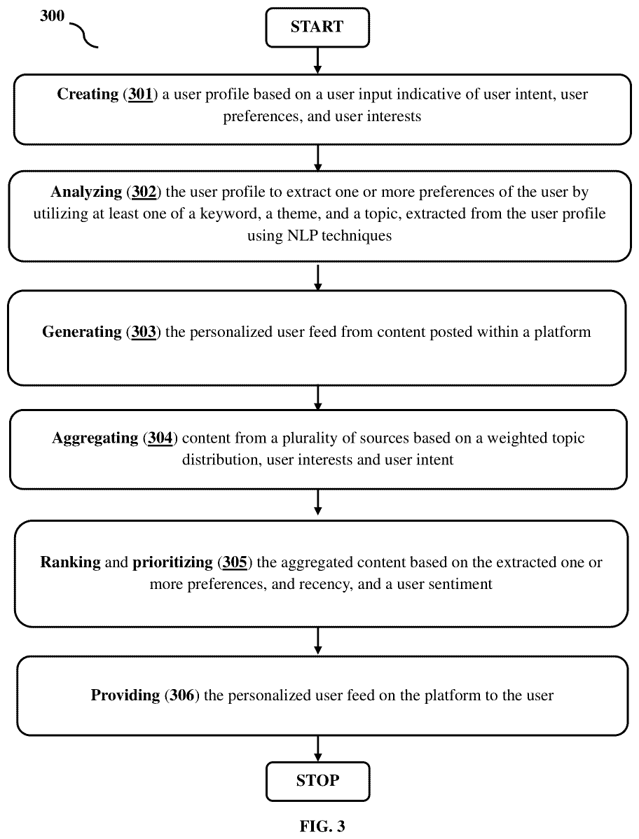

FIG. 3 is a flowchart that illustrates a method (300) for providing content via a personalized user feed to the user, in accordance with at least one embodiment. The flowchart is described in conjunction with FIG. 1 and FIG. 2. The method (300) starts at step (301) and proceeds up to step (306).

The method (300) includes a step wherein the creation unit (206) is configured for creating (301) a user profile based on a user input indicative of user intent, user preferences, and user interests. Furthermore, the user input comprises selection of at least one of an industry type, a sub-industry type, area of interest, categories, technologies, knowledge areas, country, engagement levels, functions, and demographic information of the users.

Consider the case, wherein the user has initiated the onboarding process by providing the details regarding oneself which includes selection of options related to an industry type, a sub-industry type, area of interest, categories, technologies, knowledge areas, country, engagement levels, functions, and demographic information of the users. This step ensures that only authorized user information is provided to the platform, preventing the generation of irrelevant content.

Herein, the one or more users comprises at least one of a consultant, a manufacturer, an innovator, an expert, or a supplier. The platform ensures comprehensive service to the users by meeting the needs of each type of user.

Further, the method (300) includes a step, wherein the preference identification unit (207) is used to determine the user's preferences. Herein, the preferences are organized hierarchically, with the highest priority given to the theme, followed by the topic and keyword. To exemplify this, consider a scenario where the user has created their profile and is presented with a set of specific options to choose from,
themes such as sustainability, green innovation, urbanization, digital transformation and many more;
topics such as paper, renewable fuel, electric energy, automobile, low carbon production, recycling, waste reduction and alike; and
keywords such as softwood-based paper, hardwood-based paper, cellulose based paper, electric vehicle, battery charging station, slurry treatment, and alike.

Thus, the preference identification unit (207) determines the user intent and the user preferences, and the user interests based on the keywords, the themes, and the topics. Herein, the user may disclose preferences related to a single option such as keywords, themes and themes for broad search or select combinations of keywords, themes and themes to limit the search and obtain exact relevant posts within the personalized user feed.

Further, the method (300) includes a step, wherein the NLP unit (210) is configured for analysing (302) the user profile to extract one or more preferences of the user by utilizing at least one of the keywords, the themes, and the topics, extracted from the user profile using natural language processing (NLP) techniques. Thus, incorporating natural language processing (NLP) ensures understanding of the user preferences, and user intent and transforming a way to interact with the platform.

Moreover, the method (300) includes a step of aggregating (304) user interaction data comprising clicks, likes, shares, and comments on the content by the profile management unit (208). The profile management unit (208) refines the one or more preferences of the user based on the aggregated user interaction. Further, the profile management unit (208) is configured for aggregating (304) content from the plurality of sources is based on the weighted topic distribution, user preferences, and user intent.

The step includes aggregating (304) the content by assigning a weightage to each of the keywords, the themes, and the topics based on a frequency and context within the user profile. Subsequently, the underlying themes and topics are identified from the user profile using a topic modelling technique and the assigned weightage. Herein, the topic modelling technique is selected from at least one of a Latent Dirichlet Allocation (LDA), a Latent Semantic Analysis (LSA), and a Non-Negative Matrix Factorization (NMF).

Thus, the weighted topic distribution is generated for the user profile based on the identified themes and topics.

Additionally, the user interaction data comprises an upvote, a downvote, textual feedback, and preference slider adjustment for fine-tuning the personalized user feed. Herein the user interaction data on the content is aggregated and monitored on retrieving a consent from the user. Explicit user consent facilitates tailoring the user feed exclusively based on preferences, user intent and interactions that are deemed significant, thus filtering out irrelevant and unnecessary content.

In another embodiment, the method (300) includes applying collaborative filtering techniques to identify similarities between the one or more preferences of the user and other users based on the user interaction data with fine-tuning. The fine-tuning of the personalized user feed corresponds to facilitating the user with filtered relevant content pertaining to the user interest.

Furthermore, a sentiment analysis of the user interaction data is performed by the user monitoring unit (209). The analysis aids in determining the user's sentiment towards different types of content in the feed. Further, the user into one or more community groups is categorized based on the sentiment analysis and the identified similarities. The community group enables increased connectivity among the users such as manufacturer with distributor, supplier with manufacturing, and the like.

Further, the method includes a step of ranking and prioritizing (305) the aggregated content. This ranking and prioritizing (305) may be performed by a content scoring technique. Herein, the user monitoring unit (209) is configured to employ content scoring technique based on the extracted one or more preferences, recency of the content, and a user sentiment. Moreover, the content scoring technique utilizes one or more factors comprising engagement metrics (time spent on content, click-through rate), content quality scores, and user satisfaction, ratings readability scoring, keyword relevance scoring, and user satisfaction ratings.

Subsequently, the personalized user feed is segmented into one or more categories based on the identified keywords, themes, and topics. The categorized content enables a seamless experience for the user to quickly go through the personalized user feed that may be generated.

Further, the method (300) includes a step of generating (303) the personalized user feed content from posted content within the networking platform by feed curating unit (211) based on the aggregated content, and the ranking and prioritizing of the aggregated content using the user intent and the user preferences. After generation of the personalized user feed the processor (201) may be configured to provide (306) the personalized user feed on the networking platform to the user. In an embodiment, providing the personalized user feed may comprise displaying the personalized user feed on the networking platform.

Herein the personalized feed comprises one or more of a comment, audio data, video data, a status update, an article, a blog, an uploaded file, a link to a file, a link to a web page, and a link to a record.

In an embodiment, the user interaction data is continuously monitored with the personalized feed by the user monitoring unit (209) to adjust the content in the personalized user feed. The feed is adjusted based on real-time changes in user preferences, the monitored user interaction data, and external trends. Herein, the ranking and prioritization (305) of the content is dynamically adjusted using one or more machine learning techniques.

In an embodiment, the user provides feedback on the provided content to refine future recommendations for providing (306) the content. The feedback is provided for content relevance scoring.

Thus, a person skilled in the art can readily understand that the system and the method create the personalized user feed on the basis of the user preferences, intent and consent. The present disclosure provides utility in relation to the field of B2B platform by providing relevant content in the personalized user feed

Following is a detailed working example of the present disclosure.

Consider a networking platform on the electronic device designed to provide personalized content experiences for professionals in various industries, such as an online networking platform for consultants, manufacturers, innovators, experts, and suppliers.

Users while onboarding the platform provide input about their intent, preferences, and interests. The input includes selections of industry types, sub-industry types, areas of interest, technologies, knowledge areas, and countries. The platform's processor (201) utilizes the this input to create detailed user profiles of each user.

The processor (201) extracts and analyzes the preferences to provide content with respect to the selection made by the user. Further, the processor monitors the interaction of the user with the provided content for determining the relevancy score of the content. Thus, the feed content is displayed on the platform based on a weighted topic distribution, content scoring technique, user interaction, sentimental analysis, preferences, consent, and intent of the user. This ensures the content feed aligns with each user's professional interests and preferences.

Further, the platform displays the content on the user interface in various formats, including images, text, videos, or audio. Users can access the content through personalized feeds, highlighting the most relevant content based on their profiles.

Moreover, the processor (201) segments the user profiles based on the provided input, organizing them into distinct groups with users having similar characteristics and intents.

Using supervised machine learning techniques, the processor (201) automatically identifies relevant profiles for each submitted content based on the similarity between the content features and the characteristics of user profiles. This ensures that the content is directed to the most suitable users.

Moreover, the personalized feed of the user is categorized into different sub-topics to provide easy access to the user in unearthing the relevant feed. Moreover, user feedback on the provided content is also collected to refine future recommendations and improve content delivery within the personalized user feed.

A person skilled in the art will understand that the scope of the disclosure is not limited to scenarios based on the aforementioned factors and using the aforementioned techniques and that the examples provided do not limit the scope of the disclosure.

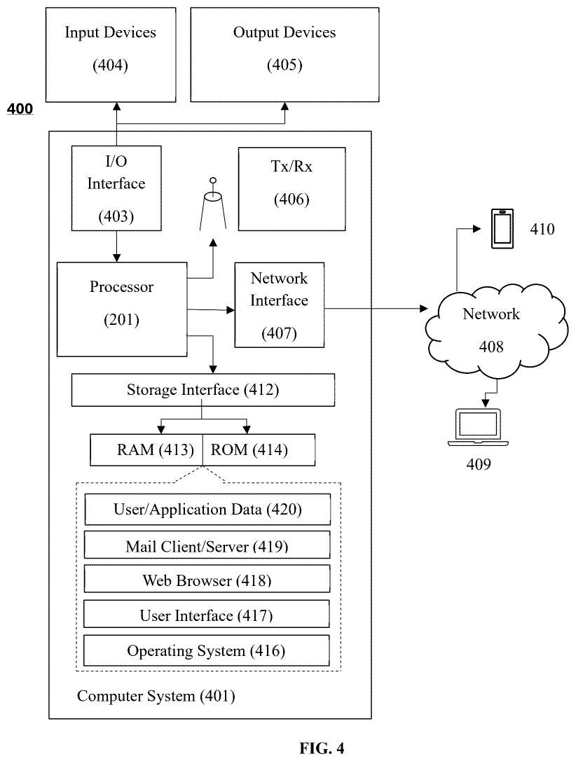

FIG. 4 illustrates a block diagram of an exemplary computer system (401) for implementing embodiments consistent with the present disclosure.

Variations of a computer system (401) may be used for creating a personalized user feed and providing the personalized user feed on the platform. The computer system (401) may comprise a central processing unit (“CPU” or “processor”) (402). The processor (402) may comprise at least one data processor for executing program components for executing user-or system-generated requests. A user may include a person, a person using a device such as those included in this disclosure, or such a device itself. Additionally, the processor (402) may include specialized processing units such as integrated system (bus) controllers, memory management control units, floating point units, graphics processing units, digital signal processing units, or the like. In various implementations, the processor (402) may include a microprocessor, such as AMD Athlon, Duron or Opteron, ARM's application, embedded or secure processors, IBM PowerPC, Intel's Core, Itanium, Xeon, Celeron or other line of processors, for example. Accordingly, the processor (402) may be implemented using a mainframe, distributed processor, multi-core, parallel, grid, or other architectures. Some embodiments may utilize embedded technologies like application-specific integrated circuits (ASICs), digital signal processors (DSPs), or Field Programmable Gate Arrays (FPGAs), for example.

Processor (402) may be disposed of in communication with one or more input/output (I/O) devices via I/O interface (403). Accordingly, the I/O interface (403) may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMAX, or the like, for example.

Using the I/O interface (403), the computer system (401) may communicate with one or more I/O devices. For example, the input device (404) may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, or visors, for example. Likewise, an output device (405) may be a user's smartphone, tablet, cell phone, laptop, printer, fax machine, video display (e.g., cathode ray tube (CRT), liquid crystal display (LCD), light-emitting diode (LED), plasma, or the like), or audio speaker, for example. In some embodiments, a transceiver (406) may be disposed of in connection with the processor (402). The transceiver (406) may facilitate various types of wireless transmission or reception. For example, the transceiver (406) may include an antenna operatively connected to a transceiver chip (example devices include the Texas Instruments@ WiLink WL1283, Broadcom® BCM4750IUB8, Infineon Technologies® X-Gold 618-PMB9800, or the like), providing IEEE 802.11a/b/g/n, Bluetooth, FM, global positioning system (GPS), and/or 2G/3G/5G/6G HSDPA/HSUPA communications, for example.

In some embodiments, the processor (402) may be disposed of in communication with a communication network (408) via a network interface (407). The network interface (407) is adapted to communicate with the communication network (408). The network interface (407) may employ connection protocols including, without limitation, direct connect, Ethernet (e.g., twisted pair 10/100/1000 Base T), transmission control protocol/internet protocol (TCP/IP), token ring, or IEEE 802.11a/b/g/n/x, for example. The communication network (408) may include, without limitation, a direct interconnection, local area network (LAN), wide area network (WAN), wireless network (e.g., using Wireless Application Protocol), or the Internet, for example. Using the network interface (407) and the communication network (408), the computer system (401) may communicate with devices such as shown as a laptop (409) or a mobile/cellular phone (410). Other exemplary devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system (401) may itself embody one or more of these devices.

In some embodiments, the processor (402) may be disposed of in communication with one or more memory devices (e.g., RAM 413, ROM 414, etc.) via a storage interface (412). The storage interface (412) may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, or solid-state drives, for example.

The memory devices may store a collection of program or database components, including, without limitation, an operating system (416), user interface application (417), web browser (418), mail client/server (419), user/application data (420) (e.g., any data variables or data records discussed in this disclosure) for example. The operating system (416) may facilitate resource management and operation of the computer system (401). Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

The user interface (417) is for facilitating the display, execution, interaction, manipulation, or operation of program components through textual or graphical facilities. For example, user interfaces may provide computer interaction interface elements on a display system operatively connected to the computer system (401), such as cursors, icons, check boxes, menus, scrollers, windows, or widgets, for example. Graphical user interfaces (GUIs) may be employed, including, without limitation, Apple Macintosh operating systems'Aqua, IBM OS/2, Microsoft Windows (e.g., Aero, Metro, etc.), Unix X-Windows, or web interface libraries (e.g., ActiveX, Java, JavaScript, AJAX, HTML, Adobe Flash, etc.), for example.

In some embodiments, the computer system (401) may implement a web browser (418) stored program component. The web browser (418) may be a hypertext viewing application, such as Microsoft Internet Explorer, Google Chrome, Mozilla Firefox, Apple Safari, or Microsoft Edge, for example. Secure web browsing may be provided using HTTPS (secure hypertext transport protocol), secure sockets layer (SSL), Transport Layer Security (TLS), or the like. Web browsers may utilize facilities such as AJAX, DHTML, Adobe Flash, JavaScript, Java, or application programming interfaces (APIs), for example. In some embodiments the computer system (401) may implement a mail client/server (419) stored program component. The mail server (419) may be an Internet mail server such as Microsoft Exchange, or the like. The mail server may utilize facilities such as ASP, ActiveX, ANSI C++/C #, Microsoft .NET, CGI scripts, Java, JavaScript, PERL, PHP, Python, or WebObjects, for example. The mail server (419) may utilize communication protocols such as internet message access protocol (IMAP), messaging application programming interface (MAPI), Microsoft Exchange, post office protocol (POP), simple mail transfer protocol (SMTP), or the like. In some embodiments, the computer system (401) may implement a mail client (420) stored program component. The mail client (520) may be a mail viewing application, such as Apple Mail, Microsoft Entourage, Microsoft Outlook, or Mozilla Thunderbird.

In some embodiments, the computer system (401) may store user/application data (421), such as the data, variables, records, or the like as described in this disclosure. Such databases may be implemented as fault-tolerant, relational, scalable, secure databases such as Oracle or Sybase, for example. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of any computer or database component may be combined, consolidated, or distributed in any working combination.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Various embodiments of the disclosure encompass numerous advantages including a method for providing content to a user. The disclosed method and system have several technical advantages, but not limited to the following:
Personalized Content Delivery: By leveraging user input to create detailed profiles and employing machine learning techniques for profile identification, the disclosed technical solution guarantees content tailored to each user's specific preferences and interests. Further, the system allows user to define their choices and govern their user experience and thereby provide a differentiated user onboarding journey.
Enhanced User Engagement: By providing relevant and personalized content, users are more inclined to engage with the platform, resulting in heightened user satisfaction and retention rates. Apart from the immediate network that the user builds, interactions and discoverability depend on the initial selections (and future alterations, if any) made by the user during his/her onboarding journey and such selections lead to enhanced user engagement. Further, explicit user content ensures that the content that is being delivered to the user is more personalized. Further, analysis of the user input to create community groups based on shared interests fosters a sense of belonging and encourages user interaction within the platform. Also, by comparing a user's preferences with those of similar users, the system can introduce new, yet relevant content that the user might not have discovered otherwise.
Efficient Content Management: Segmenting user profiles enables efficient organization and delivery of content, ensuring users receive the most pertinent content.
Data-driven Insights: Incorporating analytics and feedback mechanisms gathers insights on user interactions and preferences, facilitating continuous enhancement of content recommendations and platform performance. Further, by utilizing advanced natural language processing (NLP) techniques to analyze user profiles and extract preferences, the system ensures that the content delivered in the personalized user feed is highly relevant to the user's interests.
Flexibility and Customization: Users have the flexibility to customize their content feed and select preferred content types, frequency of updates, and notification preferences, enhancing their overall experience on the platform. By allowing users to modify the weightings of keywords, themes, and topics in their profiles provides greater control over their personalized user feed. Additionally, the ability of the system to dynamically update the personalized feed based on real-time user interactions ensures that the content remains current and engaging. Further, the sentiment analysis allows the system to adjust content recommendations based on the user's emotional response, thereby increasing user satisfaction and user engagement.

In summary, these technical advantages solve the technical problem of providing a personalized and efficient method for delivering content within the personalized user feed to the users, thereby enabling enhancement in the field of content management within a platform. Additionally, these advantages contribute to enhancing user satisfaction, increasing platform engagement, and optimizing content delivery strategies.

Furthermore, the invention involves a non-trivial combination of technologies and methodologies that provide a technical solution for a technical problem. While individual components like processors, databases, encryption, authorization and authentication are well-known in the field of computer science, their integration into a comprehensive system for creating a personalized user feed brings about an improvement and technical advancement in the field of content management within platform.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like. The claims can encompass embodiments for hardware and software, or a combination thereof.

While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments falling within the scope of the appended claim

Various modifications to the embodiment may be readily apparent to those skilled in the art and the generic principles herein may be applied to other embodiments. However, one of ordinary skill in the art may readily recognize that the present disclosure is not intended to be limited to the embodiments illustrated but is to be accorded the widest scope consistent with the principles and features described herein. The detailed description of the invention will be described hereinafter referring to accompanied drawings.

We claim:

1. A method to create a personalized user feed, the method comprising:
creating, by a processor, a user profile based on a user input indicative of user intent, user preferences, and user interests;
analyzing the user profile to extract one or more preferences of the user by utilizing at least one of a keyword, a topic, and a theme, extracted from the user profile using one or more natural language processing (NLP) techniques;
generating, by the processor, the personalized user feed from content posted within a platform, wherein generating the personalized user feed comprises:
aggregating content from a plurality of sources based on a weighted topic distribution, user preferences, and user intent;
ranking and prioritizing the aggregated content based on the extracted one or more preferences, recency of the aggregated content, and a user sentiment; and
providing, by the processor, the personalized user feed on the platform to the user.

2. The method as claimed in claim 1, wherein aggregating the content comprises:
assigning a weightage to each of the keywords, the themes, and the topics based on a frequency and context within the user profile;
identifying the underlying themes and the topics from the user profile using a topic modelling technique and the assigned weightage; and
generating the weighted topic distribution for the user profile based on the identified themes and the topics.

3. The method as claimed in claim 2, wherein the topic modelling technique is selected from at least one of a Latent Dirichlet Allocation (LDA), a Latent Semantic Analysis (LSA), and a Non-Negative Matrix Factorization (NMF).

4. The method as claimed in claim 1, wherein analyzing the user profile comprises:
aggregating user interaction data comprising clicks, likes, shares, and comments on the content, to refine the one or more preferences of the user;
applying collaborative filtering techniques to identify similarities between the one or more preferences of the user and other users based on the user interaction data;
performing sentiment analysis on the user interaction data to determine the user's sentiment towards different types of content in the feed; and
categorizing the user into one or more community groups based on the sentiment analysis and the identified similarities.

5. The method as claimed in claim 1, comprises:
continuously monitoring the user interaction data with the personalized feed; and
dynamically adjusting the content in the personalized user feed based on real-time changes in user preferences, the monitored user interaction data, and external trends, wherein the ranking and prioritization of the content is dynamically adjusted using one or more machine learning techniques.

6. The method as claimed in claim 4, wherein the user interaction data comprises an upvote, a downvote, textual feedback, and preference slider adjustment for fine-tuning the personalized feed, wherein fine-tuning the personalized feed corresponds to facilitating the user with filtered relevant content pertaining to the user interest.

7. The method as claimed in claim 4, wherein the user interaction data on the content is aggregated and monitored on retrieving a consent from the user.

8. The method as claimed in claim 1, comprises:
identifying the user intent, the user preferences, and the user interests based on the keywords, the themes, and the topics;
segmenting the personalized feed into one or more categories based on the identified keywords, themes, and topics; and
displaying the personalized feed on the platform.

9. The method as claimed in claim 1, wherein the user input comprises selection of at least one of an industry type, a sub-industry type, area of interest, categories, technologies, knowledge areas, country, engagement levels, functions, and demographic information of the users.

10. The method as claimed in claim 1, wherein the personalized feed comprises one or more of a comment, audio data, video data, a status update, an article, a blog, an uploaded file, a link to a file, a link to a web page, and a link to a record.

11. The method as claimed in claim 1, wherein the one or more users comprises at least one of a consultant, a manufacturer, an innovator, an expert, a supplier, a service provider, or other relevant stakeholder from a B2B target audience.

12. The method as claimed in claim 1, comprises receiving feedback on the provided content to refine future recommendations for providing the content.

13. A system to create a personalized user feed, the system comprising:
an electronic device configured for displaying the personalized user feed on a platform, the electronic device comprising;
a processor,
a memory coupled to the processor for storing instructions that, when executed by the processor, wherein the processor is configured to:
create a user profile based on a user input indicative of user intent, user preferences, and user interests;
analyze the user profile to extract one or more preferences of the user by utilizing at least one of a keyword, a theme, and a topic, extracted from the user profile using one or more natural language processing (NLP) techniques;
generate the personalized user feed from content posted within the platform, wherein generating the personalized user feed comprises:
aggregate content from a plurality of sources based on a weighted topic distribution, user preferences and user intent,
rank and prioritize the aggregated content based on the extracted one or more preferences, recency of the aggregated content, and a user sentiment, and
provide the personalized user feed on the platform to the user.
